(19) United States
(12) Patent Application Publication
(10) Pub. No.: US 2015/0360130 A1
(43) Pub. Date: Dec. 17, 2015

(54) MANAGING A POPULATION OF PLAYERS OF ONLINE GAMES

(71) Applicant: International Business Machines Corporation, Armonk, NY (US)

(72) Inventors: Gary D. Cudak, Creedmoor, NC (US); Christopher J. Hardee, Raleigh, NC (US); Adam Roberts, Moncure, NC (US); Adrian X. Rodriguez, Durham, NC (US)

(21) Appl. No.: 14/304,121

(22) Filed: Jun. 13, 2014

Related U.S. Application Data
(63) Continuation of application No. 14/302,477, filed on Jun. 12, 2014.

(51) Int. Cl. A63F 13/79; A63F 13/35

(52) U.S. Cl. CPC A63F 13/79; A63F 13/35

(57) ABSTRACT

A method includes determining a first target population of players in a first online game, identifying a current population of players in the first online game, and providing either (a) an incentive for at least one player in the current population to switch from the first online game to a second online game in response to determining that the current population of players is greater than the target population of players, or (b) an incentive for at least one player outside the current population to play the first online game in response to determining that the current population of players is less than the target population of players. A target population of players may be determined, for example, by correlating a parameter of player satisfaction, such as player duration in-game, with the population of players in the game.

### CROSS-REFERENCE TO RELATED APPLICATIONS

This application is a continuation of U.S. patent application Ser. No. 14/302,477 filed on Jun. 12, 2014, which application is incorporated by reference herein.

### BACKGROUND

1. Field of the Invention

The present invention relates to the management of online games that are accessible to players over a global communications network, such as the Internet.

2. Background of the Related Art

Online gaming is a large and growing industry that offers players a variety of games accessible over a global communications network, such as the Internet. Some of these online games may be referred to as Massively Multiplayer Online Games (MMOG) or Massively Multiplayer Online Role-Playing Games (MMORPG). These online games can experience large differences in the population of players between peak and off peak playing times. A game may be played by few players throughout the day and may pick up during peak times and have many players. If a players only wants to play during peak time, then those players may become frustrated if the games or certain areas of the games are overcrowded or slow.

Some online game providers have multiple MMOGs that they run and provide access to players that have paid for a subscription. For example, one provider currently has over 15 online games and has more online games in the works. Keeping players interested in playing is a key mission for such an online game provider.

### BRIEF SUMMARY

One embodiment of the present invention provides a method, comprising determining a first target population of players in a first online game, identifying a current population of players in the first online game, and providing either (a) an incentive for at least one player in the current population to switch from the first online game to a second online game in response to determining that the current population of players is greater than the target population of players, or (b) an incentive for at least one player outside the current population to play the first online game in response to determining that the current population of players is less than the target population of players.

Another embodiment of the present invention provides a method, comprising determining a first target population of players in a first area of a first online game, identifying a current population of players in the first area of the first online game, and providing either (a) an incentive for at least one player to switch from the first area of the first online game to a second area of the first online game in response to determining that the current population of players in the first area is greater than the target population of players for the first area, or (b) an incentive for at least one player to switch from the second area of the first online game to the first area of the first online game in response to determining that the current population of players in the first area is less than the target population of players for the first area.

A further embodiment of the present invention provides a method comprising determining a first target population of players following a first play style in a first online game, identifying a current population of players following the first play style in the first online game, and providing either (a) an incentive for at least one player to switch from the first play style to a second play style in response to determining that the current population of players following the first play style is greater than the target population of players following the first play style, or (b) an incentive for at least one player to switch from the second play style to the first play style in response to determining that the current population of players following the first play style is less than the target population of players following the first play style. A play style, for example, describes the player's primary actions in the game, such as crafting, trading or questing.

### BRIEF DESCRIPTION OF THE SEVERAL VIEWS OF THE DRAWINGS

FIG. 1 is a diagram of a system including a communication network enabling communication between a plurality of communication devices, including a mobile communication device.

FIG. 2 is a diagram of an exemplary compute node (or simply “computer”) that may be utilized consistent with some embodiments of the present invention.

FIG. 3 is a graph illustrating how player duration in-game can be used to determine a target player population in a particular online game.

FIG. 4 is a graph illustrating a situation when player population management would be appropriate, such as providing an incentive for players to move from Game A to Game B.

FIG. 5 is a flowchart of a method in accordance with one embodiment of the present invention.

### DETAILED DESCRIPTION

One embodiment of the present invention provides a method, comprising determining a first target population of players in a first online game, identifying a current population of players in the first online game, and providing either (a) an incentive for at least one player in the current population to switch from the first online game to a second online game in response to determining that the current population of players is greater than the target population of players, or (b) an incentive for at least one player outside the current population to play the first online game in response to determining that the current population of players is less than the target population of players. It should be recognized that maintaining the target population in an online game can improve interest and enjoyment in the game. Problems may exist in the situation where the population is either too high or too low.

The first and second online games are preferably made available by a web server and accessible over a global communications network, such as the Internet. Optionally, users obtain access to the first and second online games using a web browser to enter a uniform resource locator (URL) of the web server. Still further, the web server may be operated by an online game service provider that hosts both of the first and second online games and offers the users a subscription for access to a group of games. Typically, a user with a subscription will have an account allowing them to log in using certain credentials, such as a username and password. Activities and behaviors of the user may be monitored and such data may be stored in associated with the user's account. Accordingly, vast amounts of data about each user account may be collected and used in accordance with embodiments of the invention.

Non-limiting examples of the first and second online games may be referred to as Massively Multiplayer Online Games (MMOG) or Massively Multiplayer Online Role-Playing Games (MMORPG).

A target population of players in an online game may be a target range in the number of players. A target range may be defined by an upper threshold and a lower threshold, such that the target population of players in a number of players between the upper threshold and the lower threshold.

A target population of players in an online game may be determined using at least one parameter of user behavior regarding the online game. A preferred parameter will show some correlation with player satisfaction. For example, the at least one parameter representative of player satisfaction in the first online game may be selected from player sentiment, duration of in-game time, type of in-game activity, and combinations thereof. Player sentiment may be either player sentiment expressed in an in-game forum or player sentiment expressed in an online forum outside of the online game. In one specific non-limiting example, the at least one parameter of player satisfaction is a player sentiment obtained by monitoring player in-game comments and counting the number of instances that the player uses a word from a positive sentiment list and subtracting the number of instances that the second user uses a word from a negative sentiment list over a period of time. The at least one parameter of player satisfaction may be monitored across the entire population of players, or the at least one parameter of player satisfaction may be monitored using only a subset of players, such as those players in a threshold skill level, game level, leadership guild, particular character type or play style (e.g., adventurer, farmer, crafter, etc), or achieveing a threshold objective rate.

In one embodiment, a first target population of players in a first online game is determined by monitoring a population of players in the first online game as a function of the time of day, monitoring at least one parameter of player satisfaction in the first online game, and correlating the at least one parameter of player satisfaction with the population of players in the first online game over time. The first target population is a range of players where the at least one parameter is greater than a threshold level of the at least one parameter. In a first example, where the atleast one parameter of player satisfaction is a duration of time in-game, player satisfaction for a given player at any point in time may be determined by whether the player's current time in-game is greater than a measure of previous time in-game, such as an average time in-game or some percentile of time in-game according to the user's history. In a second example, where the atleast one parameter of player satisfaction is a type of in-game activity, player satisfaction for a player at any point in time may be determined by whether the player is engaging in a favorite type of in-game activity. A favorite type of in-game activity for the player may be determined, for example, by previous sentiment during each in-game activity or a total amount of time spent in the in-game activity relative to other in-game activities.

A target population of players may be determined for any number of online games using any of the foregoing parameters and methods. For example, the methods of the invention may include determining a second target population of players in the second online game, and identifying a current population of players in the second online game. Accordingly, an incentive for at least one player to switch from the first online game to a second online game may be provided in response to determining that the current population of players in the first online game is greater than the target population of players in the first online game and the current population of players in the second online game is not greater than the target population of players in the second online game.

The method may measure and track populations of players in one or more games, or one or more areas of the games. A history of populations in the games or areas of the games may be used to predict changes in the population. Accordingly, incentives may be provided in a proactive manner to prevent the population from falling outside the target population. Where there are more than two games available, for example in a suite of games accessible on a game server, the method may select which game(s)/area(s) have too many players and select which game(s)/area(s) have too few players, perhaps my monitoring a rate of log-ins and log-offs for each of the games. When there is an increasing rate of log-ins relative to log-offs to a particular game/area that is already near the upper threshold of its target population, an incentive may be provided to get players to move to another game. When there is an increasing rate of log-offs relative to log-ins to a particular game/area that is already near the lower threshold of its target population, an incentive may be provided to get players of other games to move to that particular game. Ideally, the populations of all games are monitored and managed to balance out the player populations in most or all of the accessible games, such that each game or most games are within their target populations.

The incentive for at least one player in the current population to switch from the first online game to a second online game may take many forms. Optionally, the incentive may be an increase in experience gains, access to items, access to certain areas or regions, a discount on subscription costs, a discount on new content, an alteration in difficulty or length of certain content, or combinations of these incentives. Furthermore, a level of the incentive to switch from the first online game to the second online game may be adjusted over time in order to achieve the target population in the first online game, the target population in the second online game, or both the target population in the first online game and the target population in the second online game. In other words, if an initial incentive does not result in a sufficient number of players moving from the first online game to the second online game, then the modify or increase the incentive. The incentive may be limited in duration to a period when the player population needs to be managed.

The method may further include selecting the at least one player from among the current population of players in the first online game. Without limitation, the at least one player may be selected based upon an amount of time since the player last played the second online game, current sentiment of the player in the first online game, the frequency that the player plays the second online game, the average duration that the player plays the first online game, whether other players associated with the player are already playing the second online game, and whether the player has a history of playing online games in the same genre as the second online game. Furthermore, the method may selected multiple players to receive an incentive, such as providing an incentive to multiple players that are determined to be friends or group members for the purpose of motivating the entire group to move from one game to another game.

According to another option, the method may include responding to receipt of a log out request from a player by prompting the player for input regarding their opinion whether the number of players was too high or too low, and determining the number of log out requests by all players, as a function to time, accompanied by input indicating the number of players was too high.

Embodiments of the present methods may also store player population history for the first online game as a function of the time of day, wherein the incentive is provided only if the current population of the first online game does not typically reach the target population level within a threshold period of time. Preferably, the player population history for each online game on the web server is stored in order to determine a target population of players for each of the online games.

Player sentiment may be determined from input that may, for example, be entered into the player's computer or mobile communication device through a touchscreen, voice commands, physical keys, or some other user interface. In various embodiments of the preset invention, the player sentiment is found in a written message. For example, the written message may be in the form of a text message, email message, online chat message, message board post, or social network post.

Optionally, online activity of the player is monitored to determine a current sentiment for the player, for example by counting the number of instances that the player uses a word from a positive sentiment list and subtracting the number of instances that the second user uses a word from a negative sentiment list over a period of time. A target sentiment may be either a numerical sentiment threshold or a sentiment category. In one example, the target sentiment is a numerical sentiment threshold, and the player is determined to be satisfied with a game experience in response to the player's current sentiment reaching or exceeding the numerical sentiment threshold. In a second example, the target sentiment is a sentiment category selected from among a plurality of sentiment categories, wherein each sentiment category has a list of words associated with the sentiment category. Accordingly, the current online activity associated with the player may be monitored to determine a current sentiment for the player, for example by counting the number of instances that the second user uses a word from each sentiment category during a period of time and determining the current sentiment category that has the greatest number of instances during the period of time. Optionally, the plurality of sentiment categories may include a positive sentiment category and a negative sentiment category.

Determining a current sentiment for the player may include analyzing content from various sources associated with the player, such as recent text messages and email messages, and recent posts to a blog or social media account, or in-game chat. The current sentiment of the player may be determined by the online game server or received from a social media server or message server. Since the player may have a variety of online accounts with various services, such as social media accounts and email accounts, the method may identify the usernames of these accounts and attribute activity under these accounts to the player. Optionally, each player may setup their online game account with profile information identifying or linking to their messaging and social media accounts.

A sentiment list may include any number of words, symbols, or phrases that indicate an attitude, thought, feeling, emotion, or expression. In a non-limiting example, a positive sentiment list may include words such as award, awesome, best, cool, enjoy, fantastic, fun, great, happy, ideal, lucky, magic, nice, outstanding, priceless, rewarding, special, terrific, and winner. By contrast, a negative sentiment list may include words such as angry, bad, critical, embarrassment, humiliation, hurt, insult, mad, offend, pain, resent, and wrong.

Another embodiment of the present invention provides a method, comprising determining a first target population of players in a first area of a first online game, identifying a current population of players in the first area of the first online game, and providing either (a) an incentive for at least one player to switch from the first area of the first online game to a second area of the first online game in response to determining that the current population of players in the first area is greater than the target population of players for the first area, or (b) an incentive for at least one player to switch from the second area of the first online game to the first area of the first online game in response to determining that the current population of players in the first area is less than the target population of players for the first area. Accordingly, the foregoing methodologies for managing the population of players between two or more games may be applied for managing the population of players between two ore more areas of the same game. For example, the method may determine a second target population of players in a second area of the first online game, and identify a current population of players in the second area of the first online game. An incentive for at least one player to switch from the first area of the first online game to a second area of the first online game may be provided in response to determining that the current population of players in the first area is greater than the first target population of players in the first area and the current population of players in the second area is not greater than the second target population of players.

A further embodiment of the present invention provides a method comprising determining a first target population of players following a first play style in a first online game, identifying a current population of players following the first play style in the first online game, and providing either (a) an incentive for at least one player to switch from the first play style to a second play style in response to determining that the current population of players following the first play style is greater than the target population of players following the first play style, or (b) an incentive for at least one player to switch from the second play style to the first play style in response to determining that the current population of players following the first play style is less than the target population of players following the first play style. A play style, for example, describes the player's primary actions in the game, such as crafting, trading or questing.

One embodiment of the present invention provides a computer program product comprising a computer readable storage medium having program instructions embodied therewith, wherein the program instructions are executable by a processor to cause the processor to perform a method. The method comprises determining a first target population of players in a first online game, identifying a current population of players in the first online game, and providing either (a) an incentive for at least one player in the current population to switch from the first online game to a second online game in response to determining that the current population of players is greater than the target population of players, or (b) an incentive for at least one player outside the current population to play the first online game in response to determining that the current population of players is less than the target population of players.

Another embodiment of the present invention provides a computer program product comprising a computer readable storage medium having program instructions embodied therewith, wherein the program instructions are executable by a processor to cause the processor to perform a method. The method comprises determining a first target population of players in a first area of a first online game, identifying a current population of players in the first area of the first online game, and providing either (a) an incentive for at least one player to switch from the first area of the first online game to a second area of the first online game in response to determining that the current population of players in the first area is greater than the target population of players for the first area, or (b) an incentive for at least one player to switch from the second area of the first online game to the first area of the first online game in response to determining that the current population of players in the first area is less than the target population of players for the first area.

Yet another embodiment of the present invention provides a computer program product comprising a computer readable storage medium having program instructions embodied therewith, the program instructions executable by a processor to cause the processor to perform a method. The method comprises determining a first target population of players following a first play style in a first online game, identifying a current population of players following the first play style in the first online game, and providing either (a) an incentive for at least one player to switch from the first play style to a second play style in response to determining that the current population of players following the first play style is greater than the target population of players following the first play style, or (b) an incentive for at least one player to switch from the second play style to the first play style in response to determining that the current population of players following the first play style is less than the target population of players following the first play style.

The foregoing computer program products may further include computer readable program code for implementing or initiating any one or more aspects of the methods described herein. Accordingly, a separate description of the methods will not be duplicated in the context of a computer program product.

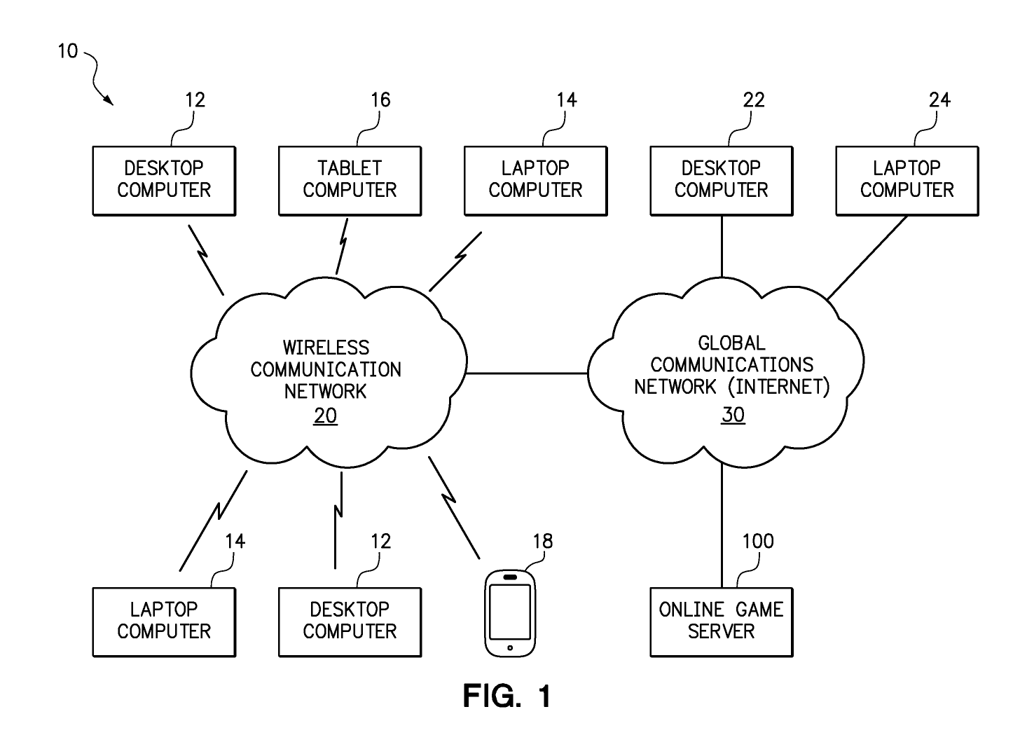

FIG. 1 is a diagram of a system 10 including a wireless communication network 20 enabling communication between a plurality of communication devices, such as desktop computers 12, laptop computers 14, tablet computer 16, and a mobile communication device or smartphone 18. The wireless communication network 20 may communication with a global communications network 30, such as the Internet. Accordingly, the desktop computer 22 and the laptop computer 24 may communicate directly with the global communications network 30 without going through the wireless communication network 20. An online game server 100 is coupled to the global communications network 30 and hosts online games. Optionally, the online game server 100 may provide accounts to users (players) of the various devices 12, 14, 16, 18, 22, 24 and allow the players to access and play the online games. The online game server 100 may monitor and store records regarding each player's activities while logged on, such as the player's preferred games, areas within games, player sentiment and duration of time in-game.

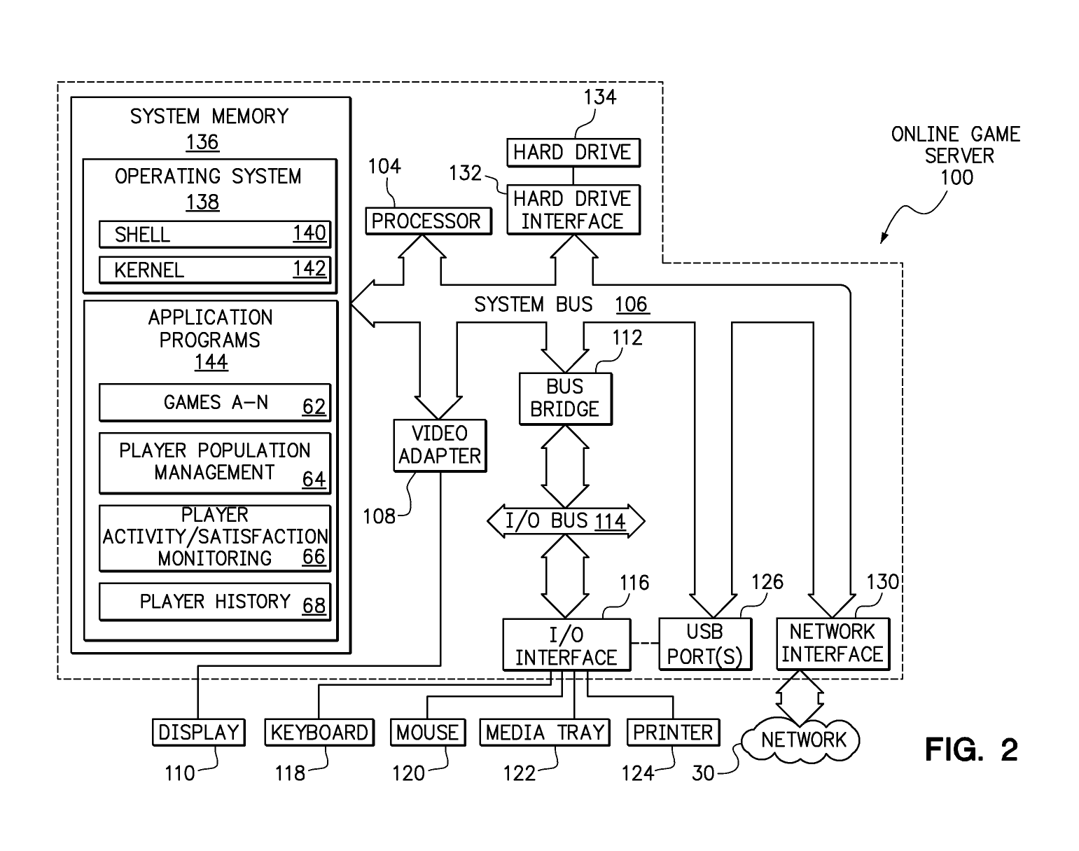

FIG. 2 is a diagram of an exemplary compute node or online game server 100 that may be utilized consistent with one or more embodiments of the present invention. The online game server 100 includes a processor unit 104 that is coupled to a system bus 106. Processor unit 104 may utilize one or more processors, each of which has one or more processor cores. A video adapter 108, which drives/supports a display 110, is also coupled to the system bus 106. The system bus 106 is coupled via a bus bridge 112 to an input/output (I/O) bus 114, and an I/O interface 116 is coupled to I/O bus 114. The I/O interface 116 affords communication with various I/O devices, including a keyboard 118, a mouse 120, a media tray 122 (which may include storage devices such as CD-ROM drives, multi-media interfaces, etc.), a printer 124, and USB port(s) 126. While the format of the ports connected to the I/O interface 116 may be any format known to those skilled in the art of computer architecture, in a preferred embodiment some or all of these ports are universal serial bus (USB) ports. As depicted, the online game server 100 is able to communicate over a network 30 using a network interface 130.

A hard drive interface 132 is also coupled to system bus 106. The hard drive interface 132 interfaces with a hard drive 134. In a preferred embodiment, the hard drive 134 populates a system memory 136, which is also coupled to the system bus 106. System memory is defined as a lowest level of volatile memory in online game server 100. This volatile memory includes additional higher levels of volatile memory (not shown), including, but not limited to, cache memory, registers and buffers. Data that populates system memory 136 includes online game server 100′s operating system (OS) 138 and application programs 144.

The operating system 138 includes a shell 140, for providing transparent user access to resources such as application programs 144. Generally, the shell 140 is a program that provides an interpreter and an interface between the user and the operating system. More specifically, the shell 140 executes commands that are entered into a command line user interface or from a file. Thus, the shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while the shell 140 is a text-based, line-oriented user interface, the present invention will equally well support other user interface modes, such as graphical, voice, gestural, etc.

As depicted, the OS 138 also includes a kernel 142, which includes lower levels of functionality for the OS 138, including providing essential services required by other parts of the OS 138 and the application programs 144, including memory management, process and task management, disk management, and mouse and keyboard management. The application programs 144 in the system memory of online game server 100 may include various programs and modules for implementing the methods described herein, such as the online games A-N 62, player population management logic 64, player activity/satisfaction monitoring logic 66, and player history data 68.

The hardware elements depicted in online game server 100 are not intended to be exhaustive, but rather are representative components suitable to perform the processes of the present invention. For instance, online game server 100 may include alternate memory storage devices such as magnetic cassettes, digital versatile disks (DVDs), Bernoulli cartridges, and the like. These and other variations are intended to be within the spirit and scope of the present invention.

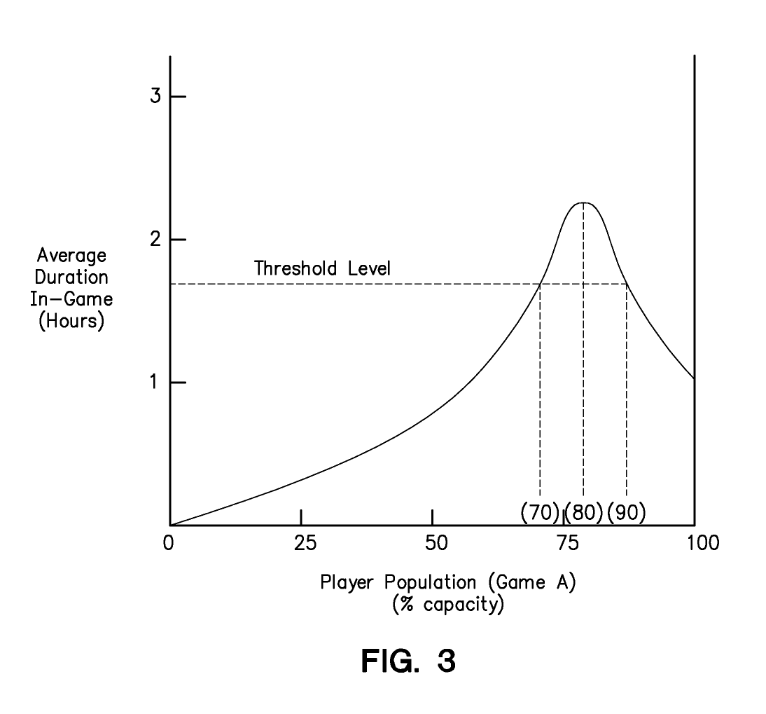

FIG. 3 is a graph illustrating how player duration in-game can be used to determine a target player population in a particular online game. Data collected from player histories is plotted to show the average duration in-game (in units of hours) as a function of the player population in Game A (in units of % capacity of players). The graph illustrates that the average duration in-game peaks at a player population of about 80% of the capacity of Game A. Since the average duration in-game is a parameter that may be representative of player satisfaction, average duration in-game may be used to monitor player satisfaction in Game A and to determine a target population for Game A. As shown, a threshold level of the average duration in-game has been set and corresponds with a target population of players that ranges from 70% capacity to 90% capacity of Game A.

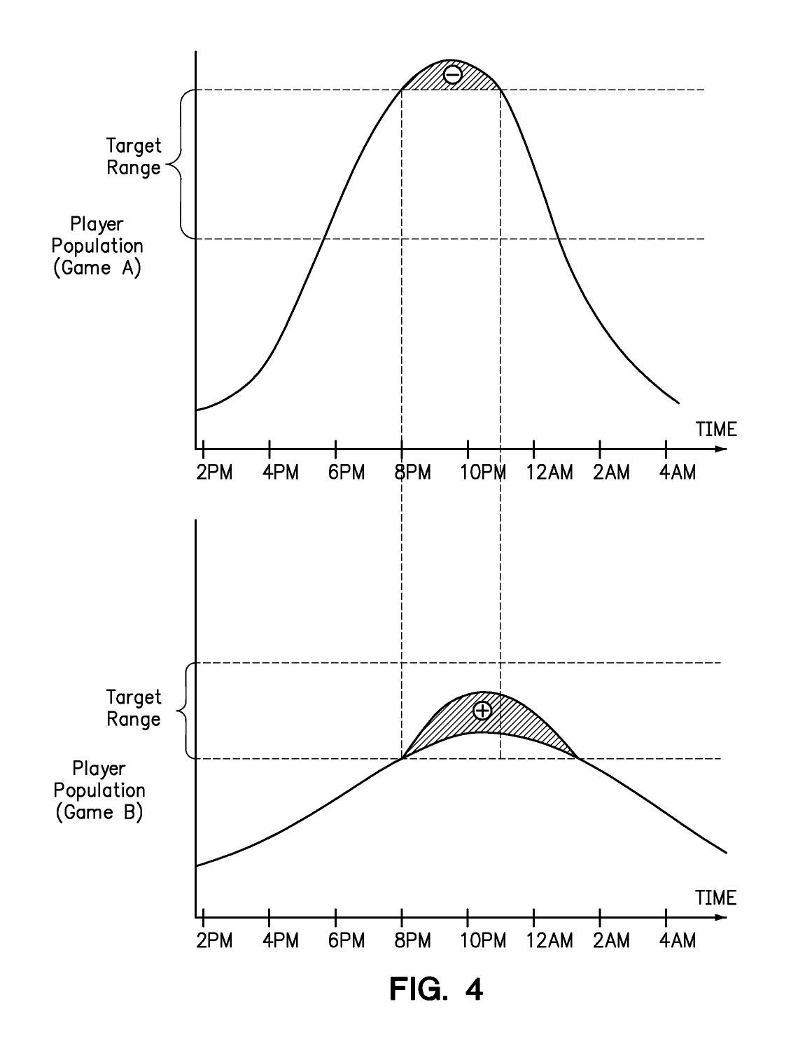

FIG. 4 is a graph illustrating a situation when player population management would be appropriate, such as providing an incentive for players to move from Game A to Game B. In the upper half of FIG. 4, the player population in Game A is shown as a function of the time of day, with a pair of horizontal lines representing the target population range for Game A. As shown, the player population exceeds that upper threshold of the target population range (see shaded area) from about 8:00 pm to about 11:30 pm. In the lower half of FIG. 4, the player population in Game B is shown as a function of the time of day, with a pair of horizontal lines representing the target population range for Game B. As shown, the player population is within the target population range for Game B from about 8:00 pm to about 1:00 am, but never exceeds its upper threshold.

In accordance with embodiments of the present invention, a number of players of Game A are provided with an incentive to move to Game B. Ideally, a number of players in Game A (the players represented by the shaded area (−)), will be enticed to move to Game B (the players represented by the shaded area (+)). Accordingly, the incentives are used to keep the player population in Game A from exceeding the target population for Game A, while the target population in Game B is still not exceeded. Beneficially, the balancing of players across the Games in this manner will increase overall player satisfaction.

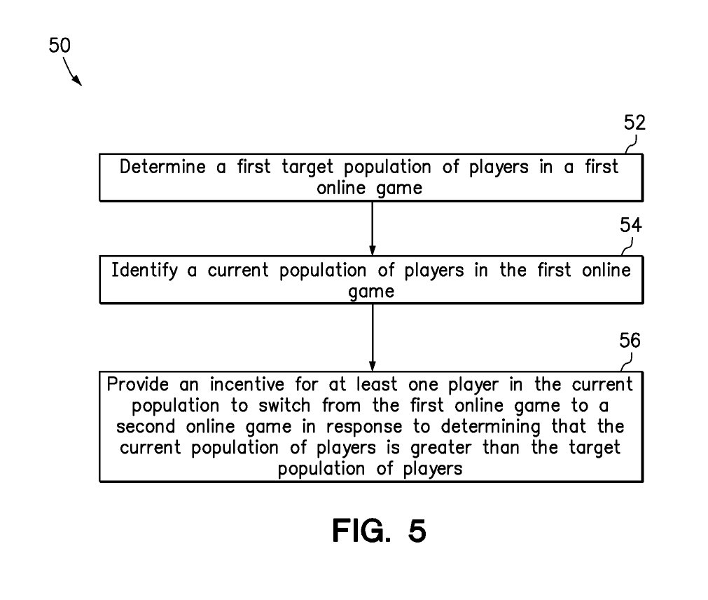

FIG. 5 is a flowchart of a method 50 in accordance with one embodiment of the present invention. In step 52, the method determines a first target population of players in a first online game. In step 54, the method identifies a current population of players in the first online game. Then, in step 56, the method provides an incentive for at least one player in the current population to switch from the first online game to a second online game in response to determining that the current population of players is greater than the target population of players.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
determining a first target population of players in a first online game;
identifying a current population of players in the first online game; and
providing either (a) an incentive for at least one player in the current population to switch from the first online game to a second online game in response to determining that the current population of players is greater than the target population of players, or (b) an incentive for at least one player outside the current population to play the first online game in response to determining that the current population of players is less than the target population of players.

2. The method of claim 1, wherein the first target population of players in the first online game is a target range in the number of players.

3. The method of claim 2, wherein determining a first target population of players in a first online game, includes:
monitoring a population of players in the first online game as a function of the time of day;
monitoring at least one parameter of player satisfaction in the first online game; and
correlating the at least one parameter of player satisfaction with the population of players in the first online game over time, wherein the first target population is a range of players where the at least one parameter is greater than a threshold level of the at least one parameter.

4. The method of claim 3, wherein the at least one parameter of player satisfaction in the first online game is selected from player sentiment, duration of in-game time, type of in-game activity, and combinations thereof.

5. The method of claim 3, wherein the at least one parameter of player satisfaction is selected from player sentiment expressed in an in-game forum and player sentiment expressed in an online forum outside of the online game.

6. The method of claim 3, wherein the at least one parameter of player satisfaction is a player sentiment obtained by monitoring player in-game comments and counting the number of instances that the player uses a word from a positive sentiment list and subtracting the number of instances that the second user uses a word from a negative sentiment list over a period of time.

7. The method of claim 3, wherein the atleast one parameter of player satisfaction is a duration of time in-game.

8. The method of claim 7, wherein determining player satisfaction for a given player at any point in time includes determining whether a current time in-game is greater than a measure of previous time in-game.

9. The method of claim 3, wherein the atleast one parameter of player satisfaction is a type of in-game activity.

10. The method of claim 9, wherein determining player satisfaction for a player at any point in time includes determining whether the player is engaging in a favorite type of in-game activity.

11. The method of claim 10, wherein the favorite type of in-game activity for the player is determined by previous sentiment during each in-game activity.

12. The method of claim 1, further comprising:
determining a second target population of players in the second online game;
identifying a current population of players in the second online game; and
providing an incentive for at least one player to switch from the first online game to a second online game in response to determining that the current population of players in the first online game is greater than the target population of players in the first online game and the current population of players in the second online game is not greater than the target population of players in the second online game.

13. The method of claim 1, wherein the first and second online games are accessible with a subscription to an online game service provider that hosts both of the first and second online games.

14. The method of claim 1, wherein the incentive is selected from an increase in experience gains, access to items, access to certain areas or regions, discount on subscription costs, discounts on new content, alterations in difficulty or length of certain content.

15. The method of claim 1, further comprising:
adjusting a level of the incentive in order to achieve the target population in the first online game, the target population in the second online game, or both the target population in the first online game and the target population in the second online game.

16. The method of claim 1, further comprising:
providing an incentive for at least one player in the current population to switch from the first online game to a second online game in response to determining that the current population of players is greater than the target population of players; and
selecting the at least one player from among the current population of players in the first online game is based upon an amount of time since the player last played the second online game, current sentiment of the player in the first online game, the frequency that the player plays the second online game, the average duration that the player plays the first online game, whether other players associated with the player are already playing the second online game, and whether the player has a history of playing online games in the same genre as the second online game.

17. The method of claim 1, further comprising:
in response to receiving a log out request from a player, prompting the player for input regarding their opinion whether the number of players was too high or too low; and
determining the number of log out requests, as a function to time, accompanied by input indicating the number of players was too high.

18. The method of claim 1, further comprising:
storing player population history for the first online game as a function of the time of day, wherein the incentive is provided only if the current population of the first online game does not typically reach the target population level within a threshold period of time.

19. A method, comprising:
determining a first target population of players in a first area of a first online game;
identifying a current population of players in the first area of the first online game; and
providing either (a) an incentive for at least one player to switch from the first area of the first online game to a second area of the first online game in response to determining that the current population of players in the first area is greater than the target population of players for the first area, or (b) an incentive for at least one player to switch from the second area of the first online game to the first area of the first online game in response to determining that the current population of players in the first area is less than the target population of players for the first area.

20. A method, comprising:
determining a first target population of players following a first play style in a first online game;
identifying a current population of players following the first play style in the first online game; and
providing either (a) an incentive for at least one player to switch from the first play style to a second play style in response to determining that the current population of players following the first play style is greater than the target population of players following the first play style, or (b) an incentive for at least one player to switch from the second play style to the first play style in response to determining that the current population of players following the first play style is less than the target population of players following the first play style.
